(19) United States
(12) Patent Application Publication
(10) Pub. No.: US 2014/0263649 A1
(43) Pub. Date: Sep. 18, 2014

(54) VISUALIZATION THROUGH IMAGING OF MACHINE-RECOGNIZABLE GRAPHIC

(71) Applicants: Walter Gerard Antognini, New York, NY (US); Thomas Charles Antognini, Lexington, MA (US)

(72) Inventors: Walter Gerard Antognini, New York, NY (US); Thomas Charles Antognini, Lexington, MA (US)

(21) Appl. No.: 13/827,242

(22) Filed: Mar. 14, 2013

(51) Int. Cl. G06K 7/10

(52) U.S. Cl. CPC G06K 7/10
USPC 235/454

(57) ABSTRACT

This invention relates primarily to a method and apparatus of visualization accomplished by utilizing an imaging device, whether as a dedicated apparatus or a standalone device such as a smartphone, or an imaging device connected to other devices such as to a personal computer with attached monitor. The imaging device of the visualization process and/or apparatus images and recognizes a machine-recognizable graphic, whether a machine-readable code or other mark or other recognizable feature and, based on instructions pre-loaded into the associated computing device, displays an image signaled by such instructions. The invention further allows the user to change the display through signals generated by the user by moving the imaging device in certain preprogrammed manners relative to the machine-recognizable graphic. The imaging device thereby becomes an input device for purposes of navigating and visualizing a wealth of details related to a base display such as a map.

### RELATED APPLICATIONS

This application is related to application Ser. No. 11/981,773, now pending, and application Ser. No. 13/573,748, a divisional application of application Ser. No. 10/837,891, filed May 3, 2004, now U.S. Pat. No. 8,281,999, which is a divisional of application Ser. No. 09/717,840, now U.S. Pat. No. 6,820,807, which is a divisional of application Ser. No. 09/382,173, now U.S. Pat. No. 6,176,427, which is a divisional of application Ser. No. 08/609,549, now U.S. Pat. No. 6,098,882, which are hereby incorporated by reference into this application in their entirety.

### BACKGROUND OF THE INVENTION

The computer age has opened up the possibility of storing and then later accessing a wealth of details about objects in the real world. Much of these details are capable, in theory, of being visualized—that is, presented in a manner that is graphic as opposed to text. This could include, for example, demographic information based on geographic location. Indeed, much of this information has been segregated based on geographic location. But another issue arises—how does the user quickly navigate through this information? How does the seeker of knowledge quickly move from a macro view of the geographically segregated data to an increasingly localized view? Certainly, a user could type in the desired parameters, but this can prove very time-consuming, especially if the user has an interest in a number of locations or wants to maneuver from one view (e.g., at the national level) to another view (e.g., the local level) and then back again.

To some extent these issues can be addressed through techniques now popular with tablet computers such as Apple™'s iPad™. This device allows a user to swipe and pinch in or pinch out (i.e., swiping a finger and thumb in opposite directions) and punch in order to change the display. But, the user must first input the parameters of the search (e.g., type in a URL for a webpage that contains such a display). Then, when presented with the display, if the user wanted to move from one side of the nation (or other geographic location) to the other, the user would need to swipe across the tablet. If the user wanted to zoom in, the user would need to apply the pinching out technique. If the user then wanted to focus on another part of the country, the user would need to first zoom out (pinch in) then swipe over to the other part of the country then pinch out to zoom in on the second local area. Anything other than a fairy limited search quickly becomes cumbersome. And that is likely the best case scenario with current technology. If the user does not or cannot use a tablet computer (e.g., the user does not have such a tablet or needs to use the information for purposes that requires printing and the tablet either does not allow for printing or allows for printing only after several extra steps, or the user needs to display the information to an audience through a projector and does not have the ability to connect the tablet to a projector), or a touchscreen, the input becomes considerably more complicated, possibly rendering access to the graphically displayed information so cumbersome as to be practically unusable.

What is needed then is a better system of input for purposes of visualizing data capable of a graphic display. The system of input would allow the user to more quickly change the focus of a display—to zoom in and/or zoom out, and to move up, down, left and right. It is an objective of this invention to provide such improved system of input. It is a further objective of the present invention that this system would allow the user to not only navigate around but also select items in the display. It is a further objective of the invention to apply the system's techniques for visualization to be applied to objects that do not have a meaningful geographic component such as to visualize the inside of a particular human body.

These and other objectives will become apparent through the description of the various embodiments.

### SUMMARY OF THE INVENTION

This invention relates primarily to a method and apparatus of visualization accomplished by utilizing an imaging device, whether as a dedicated apparatus or a standalone device such as a smartphone, or an imager (such as a scanner or webcam) connected to other devices such as to a personal computer with attached monitor. The imaging device will also have an application loaded onto it which allows the device to perform the navigation and visualization techniques described throughout this document. The imaging device of the visualization process images and recognizes a machine-recognizable graphic, whether a machine-readable code or other mark or other recognizable feature and, based on instructions pre-loaded into the associated computing device, displays an image signaled by such instructions, oftentimes in combination with instructions or signals from the machine-readable graphic. The invention further allows the user to change the display through signals generated by the user by moving the imaging device in certain preprogrammed manners relative to the machine-recognizable graphic. The imaging device thereby becomes an input device for purposes of navigating and visualizing a wealth of details related to a base display such as a map.

The preferred embodiment is best understood by reference to a globe of the planet Earth, where that globe has machine-readable codes placed on its surface as might be the case due to those codes being printed on the surface. Those machine-readable codes would preferably contain data as to the geographic location (latitude and longitude coordinates) of where the code is placed as well as instructions to launch a particular variation of an associated application once the code has been imaged and decoded. For a code placed directly west of San Francisco, for example, the code could include data indicating coordinates 37 degrees, 47 minutes North, 124 degrees West. The user, utilizing an imaging device loaded with the associated application or with access to the associated application (as through the Internet) would image the machine-readable code, triggering the launching of a variation of the application. As those terms are meant in the present context, the application is the application which allows for the method of navigation and input while the variation of the application is the more particular display or set of displays that will be presented once the instructions in the machine-readable code are executed. In the present context, the variation is a display of the globe. Accordingly, the imaging device has the application launched prior to the imaging of the code so that the imaging and decoding of the code by the device pursuant to the application will produce instructions that include the coordinates of the code on the globe as well as instructions to launch a variation of the application that will signal the application, in this instance, to produce an initial display of the planet Earth on the associated display screen. This display preferably consists of aerial imagery of the Earth, but could also consist of a map of the Earth.

The application will then allow for input from the user. In the present variation of the application, the input will allow the user to zoom in or out—in other words, display a tighter or wider view of the area (i.e., more or less area) in the center of the display, or move the center to the left, right, up or down. The invention infers these desires of the user by capturing the movements of the imager relative to the machine-readable code in various possible ways. If the user moves the imager closer to the code, the pixels of the imaging sensor occupied by the code would increase and the application would interpret this result as a signal to zoom in. If the user moves the imager further from the code, the pixels of the imaging sensor occupied by the code would decrease and the application would interpret this result as a signal to zoom out. If the user moves the imager to the right, the code will occupy pixels to the left of the center of the imager sensor, and the application would interpret this result as a signal to move the display to the right (i.e, to the east). In a similar fashion, the user could signal a movement of the display to the left, up or down.

While the preferred embodiments are described primarily by reference to a globe, the invention allows for other possibilities which are described. One such variation described allows the user to search for airline flights or hotel rooms. Another described variation allows for visualization of a street and what lies underneath that street, or otherwise underground such as mineral deposits or fossils. Another allows for visualization of objects such as the human or other animal body or inanimate objects such as laptops, ovens, engines, books and catalogs.

### BRIEF DESCRIPTION OF DRAWINGS

The present invention will be understood more fully from the specification below of the preferred embodiments and from the drawings accompanying that description, however the invention should not be taken to be limited to the specific embodiments which are for explanation and understanding only.

FIG. 1 is a block diagram describing the overall process of visualization of one embodiment.

FIG. 2 provides four alternative hypothetical images of the imaging device sensor reflecting the position of a machine-recognizable graphic, more particularly a portion of a machine-readable code, in the sensor.

FIG. 3 is a block diagram describing the invention's process of determining how to respond to changes in the imager relative to a machine-recognizable graphic, more particularly the location of a portion of a machine-readable code, in the sensor.

FIG. 4 provides changes made to a display of an imaging device as a result of selecting a circle for purposes of selecting a sub-area of the area displayed.

### DETAILED DESCRIPTION OF THE PREFERRED EMBODIMENTS

In our prior application, we described a method of navigation and input which described, inter alio, a method of displaying a map after and as a result of imaging and decoding a machine-readable code. Such method gives rise to the possibility of further enhancements and embodiments. Many of these enhancements and embodiments can be described through a base embodiment, although most are not dependent on such base embodiment. This embodiment involves a physical globe of the planet Earth. Such a globe is largely consistent with globes that have been produced for centuries. It consists of a sphere typically made from paper products with a surface printed to model the physical Earth. In the preferred embodiment, the globe would have a significant, albeit preferably largely unnoticeable, addition. The globe in this embodiment would have machine-readable codes placed on the printed surface of the globe, preferably as part of the printing of the surface.

In the preferred embodiment, the machine-readable code would be that two-dimensional code described in our prior application, now U.S. Pat. Nos. 6,098,882, 6,176,427 and 6,820,807. This code is preferred because it has, inter alio, two features of significant use in the context of the present application. First, that code has distinct features used by the previously described and patented method to locate the code even from an image in which the code is only a small part of that entire image—e.g., the code is a small part of the image of a page of a catalog. Second, that code has been specifically designed to be very efficient in its data carrying capacity. In other words, for any given amount of data, the size of the code can be smaller, oftentimes very much smaller, than codes created by others. As a result, this code would be less obtrusive than competing codes. It should, however, be understood that other competing codes could also be used, they are just not preferred.

Our prior application also describes another aspect important to the present application. That prior application, especially including the source computer code, describes in great detail the manner in which one skilled in the art could reduce to practice many of the technical aspects described herein, especially such aspects as machine recognition of graphic features.

These machine-readable codes would contain digital instructions largely consistent with methods described in our prior application—when imaged and decoded these machine-readable codes would provide instructions to the device attached to the imager (or a device that contains the imager as might be the case with a camera phone) to access a map of the area surrounding the location of the machine-readable code on the globe. The map accessed consists of data representing that map. That data might be located on the device. For example, if the device is a personal computer, the computer might contain a software application that includes extensive mapping data—software applications with these volumes of mapping data (from, e.g., DeLorme or Microsoft) have existed for many years. If the device is a camera phone or a tablet computer, as such devices might be running iOS or Android operating systems, then an app might be developed to contain such mapping data. Alternatively or in addition to this possibility of mapping data preloaded on the device, the device might seek out mapping data from an external source such as through the Internet. The mapping data that is preloaded and/or being sought out might consist of a map or it might consist of pictures of the actual area or it might consist of a hybrid of a map and pictures of the area, as such imagery is currently available through sources such as Google Earth or the Bing website. Indeed, the instructions contained in the machine-readable code might direct the device to access Google Earth or Mapquest or Bing Maps and display the map and/or other imagery from that website as is centered around the location of the machine-readable code on the physical globe. Thus, by focusing the device on the physical globe, the user might see a display of the satellite imagery of that part of the globe. The globe would thus in a sense transform into an actual picture of the physical Earth. The globe could, for example, in essence become Google Earth.

As the physical globe has become in essence transformed into a digital representation of the Earth, further digital techniques become possible. One such technique would allow for mashups of the displays. For example, focusing on that part of the globe centered around the Sierra Nevada mountain range, the display could identify the areas where forest fires are occurring. Or the display could show through satellite imagery current weather events such as hurricanes. Assuming that the globe includes machine-readable codes that signal the location (e.g., coordinates) of such code on the globe as well as instructions on where to access the mapping data from which the device will create a display, an issue naturally arises when that display will be enhanced by such techniques as mashups—how will the device know that a mashup should be invoked and if so, which mashup? One manner in resolving this issue involves a globe that has a particular purpose. For example, a globe could be dedicated to the purpose of displaying weather satellite imagery, such that the machine-readable codes contain not just location information but also instructions to locate satellite weather imagery centered around that location. Another possibility is that a globe could include machine-readable codes that contain location information as well as codes in a part of the globe that tends to be of lesser interest (e.g., as might be true in parts of the oceans) that specify which mashups to access. For example, there might be a code for weather satellite imagery, a code for recent seismic activity, and a code for display of areas affected by drought or other natural phenomenon. A user could start the process of seeking a display by first having a device image the code for the desired mashup and then imaging a code for the location. As a variation on this, the device might have a preloaded application that would allow a user to more generally select a preferred mashup or to use a mashup signaled by others. In this fashion, a publication might for example allow users to access a mashup of certain types of diseases such that by imaging the machine-readable code from the publication and then imaging a code from the globe, the user's device would display the incidence of that disease in the location selected.

While the description above contemplates that the digital data for selecting the criteria used to produce a mashup would come from a machine-readable code, the application need not be limited so. The criteria for the mashup could come from an application on a computer's hard drive or other memory, or from an application on a camera phone or from the Internet or other network source or from any other source of digital data. For example, a camera-phone could contain an application that includes average SAT scores of various colleges around the country and that camera phone could also contain the capability (perhaps as part of the same application, but necessarily so) to image the machine-readable codes on a globe (or as described below, some other source) and by combining these criteria produce a display such that when the camera phone's imager is directed over a particular geographic location, the colleges in that location (or perhaps some subset or perhaps a range if a number of colleges are contain in the location) will be indicated on the display together with each college's average SAT scores.

While the preferred embodiment is described through the use of a physical globe, this need not be the case. Most of the same functionality described herein can also be accomplished through the use of a map, preferably a map containing the machine-readable codes as otherwise described in this and prior applications. These maps may be preprinted or may be printed for a particular purpose, as might be the case for a news article printed with a map used to assist in the description of the associated news. Much of the functionality described herein could also be accomplished without any map. For example, a news article covering a hurricane could simply include a machine-readable code the imaging and decoding of which could produce the latest satellite imagery of the hurricane.

In the base embodiment, the description should be understood as utilizing an imaging device which consists of a standalone unit containing an imager, a display and associated necessary computer components as would be the case with a smartphone. Of course as also further described, the invention is not limited to this possibility, but is used only for description purposes.

With these base concepts in mind, the manner in which the invention enables the functionality described can be described by reference to several figures as follows. The more macro view of the invention is described by reference to FIG. 1. In step 102, a person interested in enabling the invention would prepare digital instructions designed to launch the visualization application. In step 104, the person would also prepare digital instructions representing the URL of the initial page that would be displayed. In the context of a globe application as described, the initial page to be displayed would presumably be some part of the planet Earth. That part would be based on and centered around the coordinates contained in the digital instructions. Presumably then, the digital instructions in this step 104 would include 1) an indication that the initial display would be some part of the planet Earth where that display would be based on either a manmade representation of the Earth (a map) or aerial imagery of the Earth, 2) the coordinates around which such display would be centered, 3) the area to be covered by such display—e.g., the display would cover 1,000 miles by 1,000 miles, and 4) the location of the data from which the display is generated where such location might be included on the device itself or from the Internet, a local network, the cloud, or some further possibility. It should be more generally understood that steps 102 and 104 comprehend the assembly of any digital instructions necessary to signal the functionality described. It should also be understood that while the application generally involves producing a display with further functionality enabled for the user, there may be variations as to what that display and those functionalities are. In the currently described context, the variation is a display of map or aerial imagery of parts of the globe.

In step 106, the digital instructions prepared in steps 102 and 104 are encoded into a machine-readable code. The details of this encoding could be, for example, as further described in our prior applications.

Some or all of these prior steps could be largely or entirely automated. For example, macros in an electronic spreadsheet could be created such that by applying the macro to a range of data cells, the codes would be automatically produced. Thus, if a range of data cells contain the average of the 3 SAT scores for each state could produce machine-readable codes for each state that would contain digital instructions to launch a variation of an application which would display scores for the nation, each region, and each state.

In step 108, the machine-readable code is placed on a medium. In the context of the base embodiment described, the medium is a globe and so the code would be placed on the globe. There are several ways in which this might be accomplished. As further described subsequently, one such manner is to print the codes on the cardboard which constitutes the surface of the globe. In other words, in making a cardboard globe, the manufacturer prints the map of the Earth onto the cardboard which will be cut and formed into a globe. That map which is printed on cardboard would contain not only the map but these codes as well. Other possibilities further described subsequently is to place a printed label of the code or stamp the code on the surface of the globe. A yet further possibility would be for individual users to place a temporary label (e.g., a Post-It™) on the surface of the globe. The use of such temporary labels might be particularly called for in the context where an old or borrowed or perhaps valuable globe or map is being used. Thus, for example, even old maps could take advantage of the invention. A yet further possibility is that the code is not physically affixed to the globe or map, but is simply put in front of (e.g., on top of) the globe or map. This might be best used in the context of a map, in which case the code could be placed on top of the map and gravity would hold it in place, or if a globe is made of steel, a magnetic code could be placed on top of the globe.

In step 110, the medium containing the machine-readable code is distributed. In the context of the globe embodiment, this step would typically be accomplished through the sale of the globe. In other contexts, the codes are distributed in some other fashion. In some contexts, the codes may be thought of as not being distributed at all. For example, after a code or codes are prepared in electronic format pursuant to the prior steps, those codes may be in an electronic image file such as a PDF or JPG. Those electronic files may then be distributed for others to print and then attach to a medium or they may be retained by the person creating such image file for purposes of being printed by such person and then placed on a globe or map for use by the person.

In step 112 the person wishing to see the display produced by the invention would image the code placed on the medium such as the globe. In the instance where a smartphone is used, the user would expose the machine-readable code to the smartphone's camera. In the preferred embodiment, the smartphone would capture a constant series of images as would be accomplished when the smartphone's camera function is set to capture a video stream. In step 114, the imaging device would decode the image of the code captured in step 112. The result of this decoding would be to reproduce the digital instructions prepared in steps 102 and 104.

In step 116, the imaging device would launch the application that produces the display and associated functionality using the variation of the application indicated in the instructions prepared in steps 102 and 104. In the currently described example, the imaging would launch the application involving a display of the parts of the Earth.

In step 118, the imaging device would display an image of the page represented by the URL from the decoded instructions. In the current context where the variation of the application involves a display of parts of the Earth with further functionality enabled and available to the user, the imaging device would display that part of the Earth derived from the decoded instructions centered around the coordinates also derived from the decoded instructions.

The specification as described by reference to this FIG. 1 has at various junctures made reference to further functionality enabled and available to the user. In the currently described variation of the application, that functionality includes the ability of the user to perform such further functions as zooming in or out, moving the display to the north, south, east or west, to toggle between map-shifting and cursor modes, and the ability to select icons on the display. The invention allows the user to take advantage of these further functionalities by manipulating the imager in such a way that the image of the machine-recognizable graphic (whether a machine-readable code, or other mark or recognizable feature) in the imager's sensor has changed in such a way and to such an extent that the imaging device can create signals derived from these changes. The manner in which the imaging device in the current invention makes these determinations is sufficiently involved that they are described by reference to FIGS. 2 and 3. To put these actions in context with the current description, in step 120, the imaging device responds to these changes in the image of the machine-readable code in the imaging device's sensor. Put another way, the descriptions provided by reference to FIGS. 2 and 3 provide far greater detail to step 120.

In further describing the actions that a user can take with regard to a display by reference to the machine-readable code, mark or other feature, it is important to understand that these actions are enabled by reference to how the user captures the code, mark or feature using the imaging device. More particularly, the manner in which the user holds the imager relative to such code, mark or other feature will change the image captured by the sensor of the imager. These changes might appropriately be considered changes in the pixels of the sensor which contain the image of the code, mark or other feature. The imaging device tracks these changes in the sensor's pixels capturing the code, mark or other feature in order to signal actions to the display, where such signals and such actions are consistent with the underlying user's intent provided that the user follows the protocol as further described.

FIG. 2 represents three of the images that can theoretically be captured by the sensor of the imaging device. It should be understood that the pixels of the sensor will actually register electrical signals of varying strength. These electrical signals of the pixels can be converted into an actual image, although for most applications described herein such a step is unnecessary. Instead the imaging device will interpret these electrical signals as, inter alio, the presence of a code, mark or other feature and so the figures in FIG. 2 can be thought of (theoretically) as representing the equivalent of an image captured by the sensor. For purposes of illustrating the theoretical capture by a sensor, the item illustrated as being captured is a machine readable code or, more particularly, the most prominent feature of the machine-readable code as described in our prior application. Our prior application provided extensive detail in how to capture and recognize this feature. This feature consists of two bars, a larger bar basically oriented horizontally, and a somewhat smaller bar, basically oriented vertically. In the first theoretical image captured by the sensor, image 202, prominent feature 204 is situated in the middle of image 202. It should be understood that this theoretical construct would occur because the user has positioned the imager such that code is directly underneath the center of the imager sensor. This possibility should be further understood as being the base possibility and that the user can signal an action by changing the pixels of the sensor which can be thought of as capturing the image of the prominent feature. Thus, if the user were to move the imager to the left, the pixels of the imager that can be thought of as capturing the image of the prominent feature would move to the right, as illustrated in image 206. Prominent feature 208 is in the left portion of image 206. The user may desire to shift in more than one direction, thereby simultaneously signaling more than one desired action. In image 210, prominent feature 212 can be thought to be occupying pixels in lower left portion of the sensor. This would occur because the user has shifted the imager up and to the right of the base location. In image 214, the sensor pixels that can be thought of as capturing prominent feature 216 are in the middle of the sensor. But the number of pixels capturing such prominent feature 216 are significantly larger than was true for prominent feature 204 in image 202. This would occur where the user has moved the imager closer to the prominent feature.

While the images in FIG. 2 have changed as a result of the user moving the imager relative to the prominent feature, it is preferable that not all such changes will signal an action. The invention will trigger a signal for an action only if the change in pixels surpasses some threshold. This is preferable because minor movements as might be caused by the unintentional shaking or other movement of the hand would preferably not be interpreted as an intended signal to produce an action. In some embodiments, however, all changes will be interpreted as signals to produce an action. If an action that is signaled is minor due to a minor movement, such signals would typically be of no great consequence.

It should also be noted that while a threshold change in the sensor pixels capturing the prominent feature results in a signal to take an action, the preferred embodiment does not allow for gradations of that action. Other embodiments, however, would allow for gradations of that action. Thus, for example, if the user shifts the imager right, the further this shift, the greater the signal to shift the display to the right and, therefore, the faster the shift of the display to the right.

FIG. 3 provides the base possibility of the logic of actions signaled based on the user's movement of the imager. Of course, in other embodiments, the logic might be different as a person skilled in the art might implement. To better understand the logic presented, one should understand that, again, the user of the imaging device can signal a desire for the invention to take various actions based on how the user has moved the imager relative to the code, mark or other recognizable feature. This base possibility assumes the following possible movements and their corresponding signs for actions to be taken:

| Movement of imager: | Action to be taken: |
|---|---|
| Closer/farther | zoom in/out |
| Up/down | display shift up/down |
| Left/right | display shift left/right |
| Clockwise/counterclockwise | action unspecified in current |
| | variation of application, |
| | but reserved for some further |
| | action in another variation |
| Quick closer/farther | selection |
| Quick counterclockwise turn and back | toggle lock of display, toggle cursor |

It should be further noted that while, as described elsewhere, the invention can operate through the use of a machine-recognizable graphic whether a machine-readable code, mark or other recognizable feature, the description of the logic by reference to FIG. 3 assumes a machine-readable code for illustration purposes. This description also assumes that in any reference to a map, the map is oriented such that the top of the map is oriented north, although it should be understood that this is only for description purposes and that some embodiments could do otherwise.

This preferred embodiment assumes that the application has been previously launched and that a display has been presented to the user as described by reference to FIG. 1, and that the invention is waiting to respond to changes in the image of the machine-readable code, step 120. The preferred embodiment operates by applying the following logic. In step 302, the user images the machine-readable code. In the preferred embodiment, the imaging consists of a constant stream of images, as might be produced when a smartphone's camera is capturing a video stream. In step 304, the invention determines whether the image of the machine-readable code has changed. Consistent with prior description, this should be understood to mean a change in the sensor pixels of the imager registering the machine-readable code. In the preferred embodiment it should be further understood that in order for the process to find a change there need be a change beyond some threshold amount so as to ignore involuntary movements by the user, but not so high a threshold as to ignore movements by the user intended to signal an action. One may safely assume that a threshold change of 10% will satisfy these criteria. If the image of the code has changed by the threshold amount, the process moves on to step 306. If the image has not so changed, the process loops back to step 302 for further imaging and determinations of any change.

Having been satisfied that a change in the image of the code has occurred, the process then determines the nature of that change. In step 306, the process determines whether the image of the code has quickly grown larger and then quickly returned to its prior size. While this step has been expressed using many terms general in description, the invention would again apply thresholds for purposes of this determination. The process would safely use as thresholds an increase in the size (in each dimension) of at least 30%, where such size is held within 10% for at least ½ second, followed by a decrease in size (in each dimension) to within 15% of the original size, all occurring within 2 seconds. If these criteria are satisfied, the process signals in step 308 to select an item contained in the display where such item is under the cursor or the display otherwise indicates that some action may be chosen by selecting it or the user has previously been advised (e.g., in the application's instructions) that selection will produce a given result. In the instance where the selection is to be an item under a cursor, the cursor would naturally need be toggled on and the cursor moved to a particular item to be selected, where these steps are further described below. Having signaled this action, the process loops back to step 302 for further imaging. If the process determines that this quick increase and return to prior size has not occurred, the process moves on to step 310.

In step 310, the process determines whether the image of the code has grown larger. Consistent with the description of step 306, this increase in size would have to fall outside the thresholds of step 306. Stately differently, step 306 would override this step 310, but only under those conditions where step 306 is satisfied. Also, if the image of the code has grown larger, then the process signals in step 312 to zoom in on the display. The invention would then present in the display an image that is presumably the same size as the prior display but covers less area and in greater detail. This could be understood as being largely equivalent to the result produced on a tablet computer when one places two fingers on the screen and moves those fingers apart on the screen. Having signaled this action, the process loops back to step 302 for further imaging. If, alternatively, the process determines that the image of the code has not grown larger, then the process moves on to step 314.

In step 314, the process determines whether the image of the code has grown smaller. Consistent with the description of step 306 and 310, step 306 would override this step 314 where the conditions of step 306 are satisfied. If the process determines that the image of the code has grown smaller, then step 316 signals the display to zoom out. Having signaled this action, the process loops back to step 302 for further imaging. If alternatively, the process determines that the image of the code has not grown smaller, then the process moves on to step 318.

In step 318, the process determines whether the image of the code has shifted left. It should be understood that the code would shift left if the imager has shifted right. This would occur where the user desires to shift the display to the right which, on a map, would be to the east. If the answer to step 318 is yes, then the process signals the display to shift right, step 320. Having signaled this action, the process loops back to step 302 for further imaging. If alternatively, the process determines that the image of the code has not shifted left, then the process moves on to step 322.

In step 322, the process determines whether the image of the code has shifted right. It should be understood that the code would shift right if the imager has shifted left. This would occur where the user desires to shift the display to the left which, on a map, would be to the west. If the answer to step 322 is yes, then the process signals the display to shift left, step 324. Having signaled this action, the process loops back to step 302 for further imaging. If alternatively, the process determines that the image of the code has not shifted right, then the process moves on to step 326.

In step 326, the process determines whether the image of the code has moved up. In the context where the imager is focused on a map and that map is lying flat on a surface, the imager is considered to have moved down if it is moved horizontally closer to the person doing the imaging. In a similar fashion, the imager is considered to move up if it is moved horizontally away from the person doing the imaging. It should be understood that the code would move up if the imager has moved down. This would occur where the user desires to shift the display down which, on a map, would be to the south. If the answer to step 326 is yes, then the process signals the display to move down, step 328. Having signaled this action, the process loops back to step 302 for further imaging. If alternatively, the process determines that the image of the code has not moved down, then the process moves on to step 330.

In step 330, the process determines whether the image of the code has moved down. It should be understood that the code would move down if the imager has moved up. This would occur where the user desires to shift the display up which, on a map, would be to the north. If the answer to step 330 is yes, then the process signals the display to move up, step 332. Having signaled this action, the process loops back to step 302 for further imaging. If alternatively, the process determines that the image of the code has not moved down, then the process moves on to step 334.

In step 334, the process determines whether the image of the machine-readable code moved quickly clockwise and then back. It should be noted that this result would be produced by the user quickly moving the imager counter-clockwise and then back again. The preferred embodiment would make these determinations by applying several thresholds. The process would safely assume that a turn of at least 60 degrees within ½ second followed by maintaining that position within 20 degrees for at least ½ second and then returning to within 15 degrees of the original position, all such actions occurring within 2 seconds should be interpreted as such signal. If this determination is made, the process would signal further actions. Overall these steps would constitute a toggle of the cursor. In step 336, the process asks whether the cursor is currently enabled. If no, then in step 338, the process of the preferred embodiment locks the display. This is done so that any further signals for movement are used to move the cursor and not shift the display. The process then enables the cursor in step 340. Having signaled this action, the process loops back to step 302 for further imaging. If alternatively, the process determines in step 336 that the cursor is enabled, then the process unlocks the display in step 342, thereby allowing signals for movement to shift the display. The process would also disable the cursor in step 344. Having signaled this action, the process loops back to step 302 for further imaging.

It should be noted that for purposes of aiding understanding, the description of the process by reference to FIG. 3 assumes that a shift occurs in only one direction. As noted by reference to image 210, the user may desire to shift the display (or cursor) in more than one direction. A person skilled in the art would understand the changes needed to the logic presented by reference to FIG. 3 in order to implement these simultaneous shifts.

Intuitively, the overall concept of the invention may be thought of as a kind of 3-dimensional mouse, with captures user intentions not just in the standard 2 dimensions, but in three—also allowing such things as rotation and tilt to play a role in capturing those intentions.

While in the preferred embodiment of the current invention, the smartphone or imager relies on visual cues in order to pick up user intentions, which are encompassed in such motions as moving the smartphone/imager up or down, right or left, in or out, rotating, tilting, etc., other methods exist to detect such motions. For example, the visual cues might be partially replaced by or supplemented with cues from RFID (or other similar) chips embedded in the physical or printed object, and read by a reader for such chips in the smartphone/imager/input device, and codes, coordinates, and movements thereby detected. As another example, an inertial mechanism in the input device, much as in many gaming devices, may also detect such movements. This information might be used instead of, in complement to, or in algorithmic combination with, visual (or other) cues to create the desired user input. Thus, it may be that a visual (or other) cue will be used to establish the first “synch point”, to establish a given coordinate on the display or printed object, and vector from that coordinate representing the position of the device. Movements from that “synch point” may then be registered using the inertial system, or, again, in algorithmic combination of the data from the inertial system with that of the visual information from the imager. The invention may also use optical cues in the display that go beyond typical static features such as a bar code or other fixed feature, such as vibrating or changing patches or colors.

A further advantage of the method involves combining geographic data with statistical data. For purposes describing the advantage, a camera phone and a globe as previously described is assumed although the method is not so limited. For illustration purposes, an example of the variation of the application assumes an article involving demographics based on census data, although again the method is certainly not limited to this particular possibility. The article assumes a discussion of the number of college graduates based on geographic location, bringing up a point that the percentage of adults with college degrees varies widely based on geographic location, but also notes some curious aberrations. This article also includes a machine-readable code consistent with descriptions disclosed herein and in prior applications. The example also assumes a globe with machine-readable codes where those codes are also consistent with descriptions disclosed herein and are of a nature that when combined with data from an external source—for example the data referenced in the aforementioned machine-readable code included with the article—the display of the computer or other device will present a mashup of a map of a geographic location with an indication of the percentage (or range) of adults with college degrees. This indication of the percentage of adults with college degrees could be graphic, such as might be accomplished with different colors or intensity of shading or other such known methods, or by indicating the actual percentage for each geographic location, or both. The method would allow the user to change the geographic location by changing the position of the imager relative to the machine-readable code containing or signaling geographic location. For example, by moving the imager closer to the machine-readable code on a globe, the geographic location displayed may change from the entire nation to a region of the nation. Likewise, the mashup could change from the entire nation to that region. So, for example, a mashup of the entire nation might show that x % of the adults have a college degree. By moving the imager closer, the Northwest U.S. might be the area of focus and the percentage of all adults with a college degree in the Northwest could be displayed. In a similar fashion, the furthest focus causes a display of the entire nation with visual indications of the borders of regions of the U.S. and the percentage of adults with a college degree might be indicated for each region. By focusing closer (i.e., bringing the imager closer to the machine-readable code) a particular region might be displayed with visual indications of the borders of particular states together with an indication of the percentage of adults with college educations for each state. The user could then move the imager closer still to the machine-readable code with the consequence of a closer focus, such as the county level and, further, to the municipality level, then the neighborhood level, the block level, etc. Thus, depending on the distance of the imager to the machine-readable code, the user could quickly grasp the demographics for the area or areas of greatest interest to the user, whether that interest might be at the national, regional, county, city, neighborhood, block or other level or some combination thereof.

As part of the method of allowing the user to focus on particular geographic locations, as would generally be the case for wanting to ascertain particular data—in the above example, the percentage of adults that have graduated from college, the method would also preferably capture the areas on which the user has chosen to focus and the underlying data, if any, relevant to that search. This data could then be used for other purposes. For example, an article in a newspaper might involve the damages caused by a hurricane and the user might, related to and enabled by that article, focus on as the geographic location a particular town on the Florida coastline. This information, the nature of the article and the location, could suggest targeted advertising by contractors that do business in that town in Florida.

As a further possibility of when capturing geographic locations might be used to good effect, a particular user may often focus on two geographic locations—for example, New York and San Francisco. This data may suggest that the user has a strong interest in these two locations and the data of that combined interest may be used to good effect. For example, travel companies might naturally use that data to good effect. An airline, for example, might provide advertising to that user concerning sales of flights from New York to San Francisco and/or vice versa.

The embodiment described above contemplates geographic location provided by data associated with a machine-readable code. That data might be the location data itself—e.g., the latitude and longitude coordinates—or some other data distinct to a geographic location—e.g., the data might indicate the country such as the USA. Other embodiments might not use any machine-readable code but instead use some other type of mark while further embodiments might use no mark at all. As an of an embodiment that uses a mark other than a machine-readable code, the method might use a mark such as a “landmark” as that term was used in our prior applications, now issued as, inter alia, U.S. Pat. No. 6,098,882. That mark as described in the preferred embodiment of such prior application consists of, essentially two solid rectangles. Techniques for identifying such mark was also described in such prior application and is otherwise now well-known. In this embodiment, a globe contains one or more marks. A device with an imager, or a device connected by wire or wirelessly (such as through Bluetooth) contains or otherwise invokes an application which upon imaging such mark performs the functions previously or subsequently described using as the geographic location the location contemplated by such mark. In one embodiment, the mark is distinct in that the application will recognize such mark as signaling the United States, preferably a particular point in the U.S., such as the geographic center of Kansas. In another embodiment, the globe contains a number of distinct marks (i.e., distinguishable from each other) where each mark represents a different geographic location. Techniques are well-known for distinguishing a number of distinct marks.

In a further embodiment, no marks are used. Instead, the methods described previously and subsequently determine geographic location based on the known distinct features of the Earth and of man-made graphics and text placed on recreations of the Earth, as would be the case, for example, of national borders and place names (such as countries, states, provinces, cities, oceans, seas, mountains and ranges, etc. printed on globes, as is the common practice). Well-known techniques for distinguishing different graphical information, or well-known techniques of optical character recognition, or, preferably, a combination of these could be used to determine the geographic location of an imager's focus. For example, the State of California has a shape distinct from any other border and therefore existing techniques designed for the purpose of distinguishing borders on a globe could determine that an imager is focusing on California. Within California, techniques could determine that the focus is more particularly on the city of Sacramento because the word, “Sacramento” is printed on the globe. The globe might contain a dot or a circle or a star very near the printed word, “Sacramento” and the method through use of these techniques for distinguishing such a dot, circle, etc, would thereby assume that the focus is at the location of such dot, circle, etc. It should be noted that such precision is not crucial to a successful use of the method described. If, for example, the application has determined that the focus is on California, it typically would not be crucial to know the exact spot of the focus in California. For example, the imager may in fact be physically focused on a spot over 150 miles away from Sacramento (e.g., in Fresno). But the method could still assume that it is focused over Sacramento and the display on the device would presumably then focus on Sacramento. By moving the imager closer, the display would zoom in on Sacramento even though the physical focus would be zooming in over 150 miles away. The difference of the focus between the imager and the display would be unknown to the user. If the user wanted to shift the focus to, say, Fresno, the user would move the imager such that the display would be moved away from Sacramento and toward Fresno even though the physical focus would be moving away from Fresno. Consistent with above descriptions, while the method described in this paragraph assumes a globe, the method could also be accomplished through a map.

In whichever manner is chosen, it can be said that the embodiments previously described associate a machine-recognizable graphic with a particular location. In some embodiments described, the location is stored in a machine-readable code. In some embodiments, the invention associates a particular graphic with a particular location based on location data not contained in the graphic but found by the invention elsewhere, such as in a database contained in the imaging device or accessible by the imaging device.

In yet further embodiments, neither a globe nor a map would be necessary. For example, a device with an associated imager could be loaded with an application and that application could be programmed to assume an established location. That application could also be programmed to function based on imaging an associated machine-readable code or a particular mark or marks. So, if the application is programmed to assume as the starting geographical location the geographical center of Kansas, upon launching the application and imaging and decoding the machine-readable code or mark, the initial display would have the center of Kansas as the display's center. The user could then move away from that geographical location to another location through physically moving the imager as described herein. In a yet further embodiment, an application largely comparable to that described would function by reference to neither machine-readable code, mark nor map. In this embodiment, essentially comparable to the above description, an application would be programmed to assume as a starting point a particular geographical location. The geographical center of Kansas could again be an example of this assumption. Upon launching the application, the device would create a display centered around the geographic center of Kansas. The device would also, through its associated imager, image whatever the device is currently pointing toward. The application would then employ known techniques to determine movements of the imager—moving left, right, up, down or moving the imager closer or further from the initial image. The device would thereby sense the user's desire to take actions affecting the display based on these movements, where such actions would be largely or entirely consistent with actions elsewhere described herein.

A previously described aspect of the invention contemplated capture of user search data for purposes of targeting advertising toward that user. In other aspects of the method, the user may specifically seek out information of commercial import, and further aspects of the invention can facilitate these searches. For example, a user may have an interest in flying from New York to San Francisco on or around certain dates. Presently existing websites allow a person to find flights that meet the traveler's criteria. But, presently existing techniques may present difficulties for the traveler. While existing websites might allow the traveler to choose a metropolitan area instead of a particular airport, choosing certain airports within that metropolitan area can be cumbersome. Likewise, while existing techniques might allow a traveler to vary the date of travel so as to minimize or optimize costs, the techniques for doing so typically require essentially a new search. The invention allows the user to more effectively manage these possibilities.

In one such embodiment, the user can vary the results by focusing on varying geographic locations. For example, the traveler may prefer to travel from LaGuardia Airport in New York (LGA) to San Francisco Airport (SFO) on July 16, departing at 11:00 A.M. By inputting these criteria into existing websites, the traveler may receive a list of flights from LaGuardia to San Francisco on that date on or near the desired flight time. But, the traveler may not be pleased with the prices of those flights and to some degree is willing to trade off convenience for cost. Certainly, the traveler could enter search criteria a number of times, performing a number of searches and then record, perhaps manually, the results of those searches. But unless the range of criteria is very limited, the search using existing techniques quickly becomes unwieldy and cumbersome.

The invention allows for an easier method of search. In one embodiment, the traveler, utilizing a personal computer, would navigate to the website of an airline and that website would have a page that displays a machine-readable code—e.g. the personal computer monitor would display a machine-readable code, preferably in a corner of the display. That machine-readable code would contain instructions signaling the functionality described below. The traveler would utilize an imager connected to the computer to first image and decode that machine-readable code. After the machine-readable code has been imaged and decoded, the computer would send a signal to the website the result of which is that the display would change to a system map of the airline's routes. The display could also contain that same machine-readable code in a corner as well two circles near the bottom of the display. By moving the imager, the traveler could change the focus of the display to the New York area and focus in particular on LaGuardia Airport. By enabling the cursor and moving that cursor toward the bottom of the display, as might be done as described by reference to FIG. 3 the user could move the cursor over the bottom right circle. The user could then take another action, such as move the imager quickly toward the display and back, which would signal selection of the circle. In another embodiment, by the user not taking any action for some period of time established by the algorithm (e.g., 2 seconds) the algorithm would infer the user's intention to select the circle and therefore select the circle. The user could then move the cursor back to the location of LaGuardia Airport on the display's map, it being understood that the cursor now consists of the circle, and that the user is in essence dragging the circle around the display. Once the circle has reached the area of the map indicated by LaGuardia, the user would then select dropping the circle on that area indicating LaGuardia. This selection could be in a like manner to the selection of the circle—e.g., a quick movement of the imager toward the display and back or, alternatively, taking no action for some threshold period of time.

The user could in a similar fashion select SFO as the destination airport. The user would disable the cursor, enabling the display. The user would then presumably move the imager away from the screen so as to zoom out on the map. Having zoomed out to a desired degree (e.g, where the display shows a map or satellite imagery 400 miles across, although the degree of zooming should be at the discretion of the user) the user would then move the imager to the left, thereby changing the display such that the display shifts west. Once the display has shifted sufficiently west that California is in view, the user would move the imager toward the display and toward the direction of SFO such that SFO is clearly indicated on the display. The user would drag the circle on the bottom left toward the spot of SFO on the display, dropping that circle on SFO in a manner previously described for the first circle.

While this method of establishing search criteria for flights as described has established which two airports the flight is between, it has not explicitly established which is the departure city and which is the arrival city. This particular criteria is preferably established, by default, in accordance with the order in which the circles are established. In the example above, the user first placed a circle over LaGuardia and then placed a circle over San Francisco airports. Preferably, by default then, the method would preferably assume that LaGuardia is the departure airport and San Francisco is the arrival airport. Of course, the method would preferably allow the traveler to vary these results. One such manner of accomplishing this is to have an icon in the display, preferably at the bottom or near the side, indicating the departure city and another indicating the arrival city. After (or before) the traveler has set a circle on an airport, the traveler could select one of these icons, which such selection might be consistent with the default or might be different than the default. Another possibility is that one circle is labeled for departure while the other is labeled for arrival.

The results of these selections are illustrated by reference to FIG. 4. FIG. 4 consists a three alternative displays produced by this variation of the application. Display image 402 represents a base display of the San Francisco Bay area in which two circles, 404 and 406, are present at the bottom of the display. These circles have not yet been selected. In display image 408, the user has moved the left circle, previously circle 404, to a new location, represented by circle 410. Display image 412 illustrates a further possibility described above. In this display, the user has dragged what was circle 404 to an area over SFO and then having selected that circle for further dragging, dragged the circle over to include OAK, creating a swath, swath 414, of selection. Stated differently, the entire area in swath 414 has now been chosen for selection and so every airport in that area is selected.

The user could then input the desired date of travel, such as might be done through a keyboard. Alternatively, the preferred embodiment would allow the user to select the date or dates of travel by again utilizing the imager. The display would also contain, preferably in a corner, a calendar. Consistent with current website practices, such calendar would preferably be that of the current and subsequent month with an arrow facing right such that the user could advance to subsequent months (and when a user does so advance to subsequent months, an arrow facing left would also be displayed so that the user could go back to a prior month). By moving the imager consistent with prior descriptions, the user could move the cursor over the calendar displayed and on a particular date in the calendar, selecting such particular date, again consistent with previously described techniques for selection. Having thusly selected the airports and dates of travel, the user could then select further criteria (e.g., round-trip, number of stops, times or ranges of time for travel) or through selection request that flights be displayed consistent with the criteria chosen. The request would then be sent to the airlines web server and a list of flights, presumably with associated prices, would then be returned and displayed.

Another embodiment allows a different manner in which to select a date or dates for travel. Instead of (or perhaps in addition to) a calendar, this embodiment includes a wheel widget as is well known in the art and current web practice. The invention would allow the user to click on an icon of the wheel widget (perhaps labeled date of flight), and by moving the imager up or down, increase or decrease, respectively, the date shown on the wheel and when satisfied with the date so shown, the user could select that date.

Many of the advantages of the present invention are brought out by further enhancements to the method of searching for travel. The example described above assumes that the traveler desires to travel from LaGuardia to San Francisco. The traveler may in fact prefer these airports but is willing to be flexible in order to achieve other desired goals, such as lower cost, a more desired flight departure time, less total travel time or less stops. The invention allows for flexibility in the manner of search in order to more easily consider these variations. The following example focuses on lowering costs, it being understood that searches that maximize other desired goals could also be performed. Consistent with the prior description, a user could search out flights from LaGuardia to San Francisco. Upon being displayed the list of results, the user may conclude that the prices are too high, or may otherwise be curious as to whether costs may be reduced. The user may also have flexibility as to the airports of travel. From New York, for example, the user may be willing to travel from either LaGuardia or Kennedy (JFK) airports, but would prefer to not travel out of Newark Liberty (EWR) or other airports. The user may also be willing to fly into either San Francisco or Oakland (OAK) airports, but would prefer to not fly into San Jose (SJC) or Sacramento (SMF) airports. The user could accomplish this expanded search by first returning to the map display (or the display could be bifurcated into a list of flights and a map), focusing on the circle centered over LaGuardia airport as was accomplished through the steps previously described. The user could then select that circle and then move the imager away from the display, zooming out the display, while also moving the center of the display slightly south (e.g., by moving the imager simultaneously farther from the display and down) so that both LaGuardia and Kennedy airports appear on the map. As the map encompasses more of the New York area (Queens in particular) the circle in the display could encompass the same number of pixels in the display. But, because the map is encompassing a larger area, the circle would likewise be covering a larger area. For example, if the circle's diameter is 10% of the width of the display and remains 10% of the width of the display, but the display is zoomed out such that the width displays 50 miles instead of 10 miles, then the circle would cover 5 miles instead of 1 mile. By zooming out and south a sufficient amount, the circle in the display could be made to cover both LaGuardia and Kennedy airports. The user could then select this circle, e.g., by keeping the imager stable for some threshold period of time such as one second. The user could then shift the display to the West coast, focusing on the display's circle appearing over SFO, selecting that circle and expanding the area covered by that circle to include both San Francisco and Oakland airports, consistent with the method used for expanding the first circle. By selecting the search option, the user could be presented with a display of the flights that originate at either LaGuardia or Kennedy and terminate at either San Francisco or Oakland. The circles could likewise be expanded to cover further airports at either departure or arrival areas. Of course, if the user desires flexibility in the search of flights from the outset, the initial setting of the circles could encompass more than one airport.

There may be instances where the setting of circles as previously described cannot be used to best reflect the user's desires. For example, if the user wishes to search for flights into San Francisco, San Jose and Sacramento airports but not Oakland airport, it may not be possible to set a circle that encompasses the 3 desired airports without also covering Oakland airport. The invention could satisfy the traveler's desired search through a further refinement. Instead of setting one circle at either end, the traveler could set multiple circles. This refinement assumes that even though the user drags a circle from the bottom of the display to a location elsewhere on the display, there will still be a circle on the bottom of the display. In other words, once a circle is dragged from the bottom of the display, there will be 3 circles on the display—the two original circles on the bottom plus the circle that has been dragged. Further circles may likewise be displayed as further described below. For example, the traveler might want to fly from either LaGuardia or Kennedy to either San Francisco, San Jose or Sacramento airports. Consistent with the description above, the traveler could set one circle to cover both LaGuardia and Kennedy airports and then shift the display to California. Once California (more particularly, that part of California that displays San Francisco, San Jose and Sacramento airports) is displayed, the traveler could first set a circle over San Francisco airport. The traveler could then move the cursor toward the bottom left of the screen to again be on top of the circle in the bottom left of the screen. The user could then drag that circle to be centered on top of San Jose airport and the user would then drop that circle there. The user could then return the cursor to the bottom of the screen to select a further circle and drag and drop that circle to be centered over Sacramento airport. The display would at this point contain 5 circles, the original 2 at the bottom of the screen plus one on each of San Francisco, San Jose and Sacramento airports. If the display were to be zoomed out, there would be a total of 6 circles, the 5 described above plus the circle that covers both LaGuardia and Kennedy airports. By then selecting search, the traveler could request a search based on these criteria—i.e., all flights departing either LaGuardia or Kennedy airports and arriving either San Francisco, San Jose or Oakland airports.

As a further manner in which a user could select locations on a map using the imager, the embodiment would preferably allow the user to not just drag, drop and perhaps enlarge a circle, but also drag, drop and continue dragging the circle as well as delete areas previously selected. To select a circle to be dragged over an area, thereby creating a path or swath of selection, the user could first drag a circle to a starting location and then, through some further mechanism such as a quick clockwise then counterclockwise movement of the imager, toggle the circle to be dragged thereby selecting the area over which the circle is dragged. These further techniques are explained by reference to the prior example, where the traveler wishes to travel into one of San Francisco, San Jose or Sacramento airports, but not Oakland. As a further manner in which to make these selections, the traveler may drag and drop a circle that covers SFO, OAK, SMF and SJC airports. Then, in order to remove Oakland from consideration, the traveler could again select a circle from the bottom left of the screen, drag that to Oakland airport (and only covering Oakland airport) and then through some further mechanism, such as the pressing of the CTRL key on a keyboard or by selecting a further icon on the display through use of the imager consistent with a manner previously described, the circle would change appearance where such changed appearance indicates to the user that wherever that circle is dragged and/or dropped, that area will be removed from selection (a “deselection” circle). Thus, by invoking such mechanism such as by pressing the CTRL key of the keyboard and then centering that circle over Oakland airport and then selecting that area as might occur by keeping the circle over the Oakland airport for some threshold period of time such as one second, that area over Oakland airport will be removed from selection and, thus, Oakland airport will be removed as a selected airport of arrival while retaining San Francisco, San Jose and Sacramento airports. A prior portion of the description indicated a manner of dragging a circle for purposes of selecting what is in essence a band the width of the circle and the length as determined by the area over which the user drags the circle. This method can also be used by the user to remove from selection a band. For example, if the area selected by dropping a circle includes San Francisco, San Jose, Oakland, Sacramento and Stockton airports and the traveler wishes to remove both Oakland and Stockton airports from consideration, the user could select a further circle at the bottom left of the display, change that circle to a deselection circle, drop that deselection circle over Oakland and then drag that circle over to the area of Stockton airport, while avoiding Sacramento.

While the above implementation is described by reference to flights, the method need not be limited to flights. The methods could also be used for trains, buses, hotels, restaurants, and other commercial applications. For example, a traveler may want to book a hotel in the San Francisco area, preferably in San Francisco. By selecting an area consistent with previous descriptions, a traveler could select the north part of San Francisco. A list of hotels available in this area for the selected dates may suggest to the traveler that the prices are beyond the traveler's intended budget, necessitating more flexibility in selection of an area. Current websites largely address this possibility by providing a list that becomes increasingly distant from the traveler's original point of selection. The ability to deftly select and deselect may be even more important in the selection of hotels. The traveler may be willing to stay in San Francisco, but not near the San Francisco airport. The traveler may be willing to stay in Berkeley and downtown Oakland but not away from areas accessible by BART. The method of selection as described above would greatly aid the traveler in making these selections, returning a list of hotels better suited to the traveler desires while also optimizing for price.

Even in the San Francisco airport area, the traveler may be willing to stay at those hotels within reasonable walking distance of BART but not otherwise. The traveler may be willing to stay at hotels that are at least 3 stars only. By making a selection of areas of interest, the traveler may focus attention on the most appropriate hotels. To further enhance this process for the traveler, the display could indicate not just a map or satellite imagery, or a hybrid of satellite imagery with street names and other graphics, but also icons of the hotels within the area of selection. If the area displayed is relatively large (e.g., a square that is 20 miles on each side) the icons would presumably need to be relatively small and in some areas grouped together into one icon. If the area is zoomed such that it is a square of say 5 miles on each side, each hotel might have its own icon. As the area is zoomed in further, the icon could include not just the icon but also the name. And further zooming would allow details about each hotel such as address, star rating, average price rates for the chosen dates, etc. At many of these levels, the invention would allow a further possibility. The icon could include a special mark, that could include a machine readable code, and by focusing the imager on that mark, the user could invoke a separate web page or website related to that particular hotel. This might be especially true if the hotel has paid for the ability to include such a special mark in the mapping application to be associated with that hotel's icon, especially where the user would be redirected to the hotel's own website.

Of course, the method's ability to allow a user to quickly access more information about a hotel is not limited to focusing on an on-screen icon. As another option, the user could access this further information by simply focusing the cursor on the icon for some threshold period of time or otherwise “selecting” that icon consistent with methods previously described. It should be understood that because the method “knows” the geographic location of the cursor (i.e., the method has placed the cursor at a particular location on the map display and the method has stored the contents of the map display and so the method can determine from these data the geographic location represented by the point of the cursor), if the user were to make a selection based on the location of the cursor the method would be able to determine which icon the user had selected and display the appropriate data (e.g., website) of the associated hotel.

The method of accessing information for hotels described above preferably displays all of those hotels within the geographic area displayed, provided that those hotels are consistent with any search criteria (e.g., star rating) established by the traveler. As another possibility, the traveler could, in a manner consistent with the description of flight selection above, place circles or paths (i.e., dragging a circle over a geographic area) establishing the area for hotel searching. With either method of establishing the area for search (i.e., the entire area of the display or only those areas within the display selected by the traveler), the method of search could provide a further enhancement to ease the traveler's selection process. Instead of the map (or other geographic display) filling all or a substantial part of the overall display, the map etc. could comprise one panel of the display where at least one other panel could display information about the hotels within the area established for search. For example, the left half of the display could consist of the map etc. while the right half could provide information about hotels within the area of the display selected for search. This would allow the traveler to see the information about the hotels without the need to change screens away from the map and without the information (or most of the information) being superimposed on the map, etc., thereby interfering with the map display. As the traveler zooms in, as previously described, and the number of hotels within the area of display is reduced, the details provided for each hotel could increase and so the traveler could select the level of detail by zooming in and/or out. The traveler may want to start with just the basic details (as would be provided by a wider view) and then gain greater details as to a particular hotel or hotels (as would be provided by a tighter view).

### Further Embodiments

### Placing Machine-Recognizable Graphics on Roofs, Etc.

In the embodiment where the icon includes or can include a machine-readable code or other mark (presumably one in which a computer monitor displays a map and the user then uses an imaging device focused on the computer monitor), another possibility arises. While the method to this point assumes that a mark will be entirely electronic—i.e., part of the display will include a certain number of pixels that make up that mark, the mark could in essence comprehend both a physical and electronic existence. This possibility would be especially appropriate where the map being displayed consists at least in part of satellite or other actual (presumably aerial) imagery. In this instance, a hotel or other interested party could place on a roof or a parking lot or other area viewable from above a physical mark that could be imaged by satellite or airplane or other device and thereby become part of the imagery displayed by the method. Current websites, such as Google Earth, provide actual imagery of, for example, the United States. This imagery is renewed from time to time. If a hotel or other interested party were to place a mark (capable of being recognized by the method described herein) on their roof, parking lot, etc., then the next time the imagery is renewed, that mark would, by default, be included as part of the imagery that that website would display. Presumably, that mark would need to be rather large so that it would appear as a sufficient number of pixels in the geographic imagery to be recognizable by the method described herein. If that same imagery were to be used by the method described herein then that mark could be imaged by the user and the method could then signal the application to access the website or webpage represented by that mark. Of course, while that mark would by default appear as part of the geographic imagery, the producer of that geographic imagery could presumably remove the mark prior to displaying the imagery or prior to passing the imagery on for use by the present method or could remove the mark unless a fee is paid to continue the mark for such further purposes as making it available to the present method.

Further to the possibility of an establishment displaying a machine-readable code or other mark on its roof, parking lot or other open area, a business or organization could provide many such codes or marks not for itself, or not just for itself, but for others as well. This might be especially called for in areas where there is a great deal of space open to satellite or other aerial photography. Such a person could, for example, have acres containing such codes and could be known for providing such codes so that others would know to look at a particular geographic location to find such codes. As another possibility, codes could be provided for unusual circumstances. For example, if a natural disaster has hit a particular geographic area, codes could be put out in those areas indicating that to contribute to a particular charity relief, image and decode the code to make a contribution. This method could also be used to good effect as a means of communication. A code displayed from a rooftop in a disaster area (where communications have otherwise become unavailable) could indicate that all members of the Smith household are safe. Or perhaps more importantly, such a code could indicate distress, including the urgency and nature of that distress. These areas would presumably be imaged on a fairly regular basis given the circumstances. And, this aerial imagery could be made available for public access, which to some extent is current practice—Google, for example, regularly makes available imagery from disaster areas soon after the disaster has struck. Adoption of these techniques might very well expand the efforts by companies such as Google.

As a further possibility, possibly in addition to the inclusion in the geographic imagery, the entity maintaining the website for the provision of the geographic (e.g., aerial imagery) display could superimpose its own marks (e.g., machine-readable code) over the aerial imagery displayed. In this way, for example, the geographic display could include the actual marks that businesses place on their roofs, parking lots, etc., as well as the purely electronic marks superimposed. These dual sources would preferably be transparent to the user. Superimposing the marks might be especially appropriate for commercial purposes. The entity maintaining the website could make a compelling argument for why business establishments should pay for the superimposition of the marks—for example, it would save the business the expense of physically painting or otherwise placing a mark on their premises. One advantage, however, of placing a physical mark such as a machine-readable code on a roof, etc. is that any application that images the appropriate machine-readable code for purposes of linking to the Internet (such as currently exist) could be used to link to a website of the business.

### Visualization of Earth's Internal Features

The invention as discussed thus far assumes that by moving an imager closer to an associated mark, a user will signal a display that zooms in and, alternatively, that by moving an imager further away the user will signal a display that zooms out. There are other embodiments that change the display focus to something other than this focus which is entirely or largely two-dimensional. In one such embodiment, by moving the imager closer to an associated mark on a map or globe, the user will signal a display of what exists underground and the user can vary the depth (i.e., how far underground) by moving the display closer or further from the mark. For example, a globe within such an embodiment could be used for educational purposes. A student can see the surface of the globe, but not what is underneath. Through use of the present embodiment, the student could focus on the various underground aspects of the planet. At a relatively large distance (e.g., by moving the imager closer to the mark by just a small amount) the student might see topsoil. Moving the imager a small amount closer, the student might see that part of the Earth's crust that lies underneath the topsoil. By moving the imager closer, the student might see the Earth's mantle, then the outer core, then the inner core. Obviously, there can be further variations.

### Visualization of Structures Beneath Streets

The techniques described above can be used to good effect for applications beyond the merely educational. A diagram of a street surface area (as might be produced as part of a survey used for architectural purposes) could become quickly confusing when layers of infrastructure are indicated. The street (pavement) may appear on such a surface area survey. But, water pipes, sewer pipes, gas lines, telecommunication wires or conduits, transportation tunnels and tracks, as well as other infrastructure (or other physical features such as underground streams or faults) of significance may exist underneath the physical surface of the street. While these other features may in theory be printed (or for electronic versions, displayed) on the street surface area diagram, this presentation can present at least two issues. First, as the number of such features increases, the potential for confusion will also increase. Second, even if there is just one such item, a printing of the feature on a physical media (e.g., paper) or electronic display does not give an immediate impression of how such feature relates to the surface or other features. Hopefully, a legend will be available such that the reader can make such determinations of how such features relate to each other. But this process may easily prove non-intuitive, slow and cumbersome. An improvement would be the addition of a process in which a display would allow a user to focus on various depths underneath the street such that the user could more intuitively see on the display how the locations of the features relate to each other. The embodiment described here allows for such a process.

A street surface area diagram could include machine-readable codes or other marks or other indicators recognizable using known algorithms. In the preferred embodiment, the diagram includes a machine-readable code where that code includes information on the location (such as the coordinates) as well as instructions to signal the application described as follows. Pursuant to this preferred embodiment the user images the machine-readable code and the imaging device then decodes the code. The decoding will then trigger a display of the street surface area, preferably presenting on the display the actual street surface. This could include, for example, a footprint of any objects on the street (e.g., fire hydrants, curbs, etc.) as well as textual information, such as street name, address, coordinates, distances from other streets, etc. By moving the imager a small amount closer, a signal could be triggered to change the display from the street surface to just underneath the surface. Perhaps the display would show the dirt (or other material) under the pavement. By moving the imager a small further amount closer, a signal could be triggered to display a further layer deeper down. Perhaps the display would show water pipes and electric conduits. By moving the imager small further amounts closer, even deeper layers could be signaled for display. As part of the display of each layer, the display would preferably also indicate the depth of the layer being displayed. While this description assumes that the display is dependent on the depth underground, other embodiments could allow for other possibilities. For example, the layers might not be based on depth (or not entirely on depth) underground but on some other factor. One such layer may present all electrical features regardless of depth. Another such layer might present all water pipes regardless of depth.

While the above description is by reference to a street surface area diagram, such functionality could likewise be accessed via a map or via machine-readable codes, marks or other distinguishing features on the actual street. It should be understood that all of these sources, a street surface diagram, a map or the actual physical street have inherent latitude and longitude coordinates and that as long as the source has these coordinates built-in, the invention can perform the visualization described. Thus, for example, an architect could visualize the underground layers at a particular spot by imaging a machine-readable code on a street surface diagram, or if at some point this is not available, on a map (provided that the architect has access to the application and appropriate data for the location, as might be achieved by accessing that database through a secured Internet connection to the architect's office server) or if the architect is on-site, by using the actual latitude or longitude coordinates (as might be provided by a GPS receiver or by placing a mark or machine-readable code on the ground) again in combination to access of the database as might be accomplished by accessing it through a secured Internet connection to the architect's office server or by accessing the database on a portable device carried by the architect such as a laptop or smartphone, tablet, etc.

### Visualization of Mineral and Geologic Formations

In a somewhat similar application, the embodiment expressed above could be used for purposes of visualizing physical features that exist further underground. This might be important, for example, in the field of mineral exploration. The embodiment would allow an engineer to visualize the rock layers that exist above and below sought after mineral deposits. The information for these layers might come from tests performed at the particular site being visualized or from extrapolation of similar sites elsewhere or from well-known information of such layers more generally or, preferably, a combination of all such sources. What the present invention adds is not this knowledge per se, but an improved manner of visualizing such information. Thus, if an engineer has concerns that digging directly down to a mineral deposit presents difficulties due to an obstacle in the way, that engineer may seek to dig at an angle. While data presumably exists indicating what obstacles may exist if digging at an angle, understanding such obstacles based on current techniques may be slow and cumbersome. The present invention allows a quicker and more intuitive manner in which to understand those obstacles. By moving the imager one way (e.g., to the right) the engineer can view an area to the east. By moving the imager closer, the engineer could observe layers that are deeper. By moving the imager farther away, the engineer could observe layers that are closer to the surface.

### Visualization of the Human Body and Other Organisms

These techniques could also be used to good effect for purposes that do not at all relate to the Earth's surface. These techniques could also be used to good effect for medical purposes. In one such application, the techniques could be used to visualize human tissues, organs, bones, blood vessels and other anatomical features. In the preferred embodiment, a machine-readable code would first be placed on the skin of a patient. This could be accomplished by printing out such a code on paper and then placing that code on the skin. Or, the code could printed on a label or other media with adhesive backing and placed on the skin so that the code would be less likely to move. That code could contain the name of the patient, an identifying number (e.g., patient number or Social Security number), the body location of where the code is being placed as well as a signal to launch the application to enable the process described as follows. The code could also be stamped onto the patient or tattooed such as through the use of henna. In other embodiments, a mark is utilized instead of a code where such mark could be printed and placed in the fashions described previously. In some embodiments, the mark is hand-written onto the patient's skin through use of a marker or other writing device. A medical personnel could, for example, place a “+” sign on the patient's skin and this, together with input of the location of such mark (e.g., 3 inches down from the left wrist) could be used to determine location. In other embodiments, the invention determines location by reference to known marks on the patient's skin, such as freckles, moles, scars as well as the shape of the body part to be imaged—e.g., the wrist has a unique shape which when combined with other known features can be used to determine location on the patient's body. In other embodiments, a combination of machine-readable code or codes and/or man-made marks and/or naturally existing features could be used to determine body location.

The embodiment also assumes fairly extensive anatomical data. Some of this data can come from this particular patient, as might be derived from X-rays, MRIs, CAT scan, sonograms, photography (e.g., from prior surgeries, colonoscopies, laparoscopies, etc.) or other such sources. Some of this data may come from what is known more generally about human anatomy (presumably especially as provided by photographic imagery) as might have been discovered over the many centuries from dissections, autopsies, etc. Preferably, the data derives from a combination of these sources. Thus, while general knowledge of human anatomy could be used by default, this default would be modified by what is known about this particular patient. As a further feature, the invention could use as data not only that which is known about human anatomy and this particular patient but also that which can speculated about the patient. If, for example, the patient is presumed to have a tumor, but the size of the tumor is unknown, the data used could include various speculative possibilities relating to tumor size. These “what-if” possibilities could then be visualized without surgery (quite possibly prior to actual surgery) in order to give a clearer sense of how a tumor of various sizes could impact surrounding tissues, organs and other anatomical features. Indeed, the invention would preferably allow the medical personnel to vary visualizations based on these varying hypothetical tumor sizes through use of the imager. In one such embodiment, the user could press a button on the imager or on a keyboard or on a mouse or on the display (presumably by touching an icon on a touchscreen display) or through some other input part of or to the imaging device (whether such imaging device is a standalone unit such as a smartphone or a combination of imager, computer, display etc.) and then move the imager in one direction (e.g., closer to the skin to signal a larger tumor, further to signal a smaller tumor) so as to signal a request to vary the hypothetical tumor size in the desired manner whereupon, the embodiment would alter the combination of data used to produce the image displayed such that the tumor would change in size in the display.

In a perspective consistent with the discussion of Earth's features, the invention's strength lies in the manner in which all of the data can be visualized. In theory, all of this data could be inspected without use of the invention. The invention allows a valuable perspective on the viewing of the data. For purposes of further discussion, a medical personnel is assumed to be using the invention, although this certainly need not be the case, especially considering the non-invasive nature of the method. It might be very useful, for example, to allow the patient him or herself to use the visualization techniques described for such potentially critical important purposes as informing the patient as to the patient's medical condition. Certainly, the techniques could also be used for educational purposes, as might be true in a biology or anatomy class. But in the further described embodiment, a medical personnel is assumed. The medical personnel would focus the imager over the machine-readable code, mark, skin feature, etc. as such visible distinctions have been previously described. The invention would recognize these visible distinctions in a manner as previously described as well as using known techniques for recognizing distinct features. In this way, the invention would determine the body location being imaged and the application would display the skin for that body location. The medical personnel could then move the imager to the right or left and/or up or down to change the body location. The medical personnel could also move the imager slightly closer to the skin so as to signal a desire to see underneath the skin. A slight inward movement could signal a desire to look just under the skin at the dermis. The imaging device (i.e., the device performing the imaging as well as other functions including a display as might be true for a smartphone, or a combination of an imager and other devices performing other functions including a display, as might be true for a camera attached to a desktop, laptop or tablet computer) would then produce a signal to change the display to that of the dermis. The display of the dermis would, consistent with prior description, be based on imagery of this particular patient, imagery based on more general human anatomy or some combination of these. A slightly greater movement toward the skin could signal a desire to view deeper under the skin, perhaps of the layer containing blood vessels. An even closer movement toward the skin would signal a desire to display even deeper layers, such as the bones. These signals would be produced by the computing device (which as previously described could be the imaging device itself) and that device would seek out the data for the layer thus signaled and produce a display of such layer based on the data derived.

As another feature of the present embodiment, the invention would allow the user to vary the amount of depth to display. The embodiment might by default display a two-dimensional representation of that which exists at a certain distance underneath the skin. This view may of limited usefulness in many instances. A visualization of a three-dimensional space might often prove to be of greater use. The present embodiment would allow the medical personnel to vary the depth of the three-dimensional view. The preferred manner of doing this would be by the medical personnel tilting the imager as might be done by moving the part of the imager closest to the user upwards which would simultaneously move the part of the imager farthest from the user downward. Thus, for example, the medical personnel could visualize an entire artery or an entire bone, or only part of a bone, as best suits the needs of the user.

The desired overall effect of this visualization method is akin to what would be produced by observing through use of surgery but with many significant advantages. First, of course, the method of visualization would not require surgery, although the techniques could be used while surgery is being performed as might be appropriate where the surgical team desires to gain a better sense of the proximity of certain anatomical features, such as blood vessels, that have not been exposed by the surgery. This possibility might be aided where the surgeon or other medical personnel utilizes a device such as Google Glass, which would allow the medical personnel to see the actual patient while Google Glass could image the machine-readable code, mark or other physical feature, recognize such code mark or feature, thereby signaling the visualization technique which would then trigger the display on Google Glass, which could then be used to supplement the actual view of the patient. Second, surgery could have side effects that obscure the ability to observe, such as blood. Third, surgery would reveal only those features that have been exposed by the surgery and it would seldom make sense to cut more than absolutely necessary. Thus, even with surgery, many features might be left unobserved. Many other advantages could ensue. For example, surgery would seldom make sense for a casual observation of anatomical features, such as might be appropriate for educational purposes. Surgery would not be appropriate for purposes such as providing to an expectant mother enhanced imagery of her unborn baby. Through data from this particular mother, such as through a sonogram, combined with data more generally known about fetuses and human anatomy, the mother could be presented with a display of her unborn baby that is closer to an actual image of the fetus than the grainy image produced by a sonogram even though in reality such a display would largely consist of interpolated data. To the present point, such enhanced imagery would not require the potentially catastrophic effects of surgery.

While the prior description has largely assumed that the data being used is static—i.e., pre-existing data—this need not be the case. For example, in the context of viewing an unborn child, the data could be a combination of pre-existing data such as the photographic imagery of other fetuses gathered over decades and prior sonograms from this particular mother as well as the feed from a sonogram being currently performed. With this dynamic embodiment, a medical personnel or the mother herself could visualize the unborn baby moving in utero in real time. Thus, as the unborn baby actually kicks, the display would present the baby kicking.

While the embodiment for visualizing the tissue of an organism has been described by reference to a living human body, such techniques could be used to good effect for other organisms. The embodiment could be used for the visualization of other animals, which might be particularly useful for less common animals. The embodiment could also be used for dead organisms, as might be appropriate to aid in autopsies, necropsies and examinations of fossils.

### Visualization of Inanimate Objects

The use of these visualization techniques appropriate for organisms can be likewise useful for inanimate objects. In one such application, a laptop computer could have machine-readable codes or other marks or, consistent with previous descriptions, other identifiable features recognizable by an imaging device. A user such as a computer technician could use an imager to acquire, recognize and, in the case of a machine-readable code, decode any included instructions, from such machine-readable code, mark or other feature. The imager could then be used in manners previously described to visualize the components of the laptop including their juxtaposition to each other. This application once again assumes existing data on the contents of the laptop. In the instance of the laptop, presumably more so than a human body, the contents could be well documented, as might be done by the manufacturer. This preexisting data could be supplemented by data known about this particular laptop or by data that is speculated about this particular laptop. For example, if a technician suspects that a cable to a hard drive has become loose, that data could be combined with preexisting data about this model of laptop so that the invention would allow the technician to visualize the inside of the laptop without actually opening the laptop. This hypothetical imagery may reveal, for example, that the cable is touching or nearly touching on some other element that may have caused a short, leading to the problem for which the laptop was submitted for inspection and repair. Given this information, the technician may advise the client of the likely problem and suggest opening the laptop for confirmation of the problem and the likely need for a corresponding repair. Such a visualization has at least two advantages over initially opening the laptop. First, it can take several minutes of a skilled technician's time to open and then close a laptop. Second, there is always some inherent risk of damage in opening the laptop, especially if done by a person lacking sufficient skills, such as the consumer him or herself. In the latter possibility, opening the laptop presents a further issue—the potential of voiding the warranty. The visualization suggested herein would allow the consumer to “see” inside without actually opening the laptop.

The same functionality offered for a laptop could likewise be used to good effect for physical items that could prove much more difficult to open up (and then close) for physical inspection. An engine might be visualized using these techniques. So might an oven or refrigerator. Such visualization techniques might be particularly important in the context where opening the item might itself prove significantly harmful to the item or otherwise. This might prove useful in the context of an item that has been factory-sealed and that cannot be resealed outside the factory. Also, in the case of an item that contains nuclear or toxic or potentially harmful biological elements, opening the item might prove problematic due to the potential release of these harmful elements. In such instances, the ability to visualize the inside without opening the item could prove invaluable.

While the description of these visualization techniques has been given for both two-dimensional and three-dimensional items, the invention allows for a further possibility, the visualization of an item traditionally viewed as two-dimensional on a three-dimensional basis. This possibility is described by reference to a catalog. A catalog is literally three-dimensional. But the user of a catalog views only two dimensions at a time. The techniques described herein can be used to quickly peruse through the various pages of the catalog. The catalog could have a machine-readable code printed on it's cover, preferably the front cover. This code could contain signals that reference an online site. By moving the imager closer to the code, the user could signal the application to move further into the catalog. In this manner the user could quickly peruse either the entire catalog or those portions of the catalog of greatest interest to the user. If the catalog is for a home appliance retailer for instance, the customer might be interested in only refrigerators. The index may indicate that refrigerators are displayed on pages 31 through 38. The invention would allow the customer to quickly go to these pages to view the contents. Of course, the customer could also physically turn to pages 31 through 38. But the invention offers several advantages. First, if the customer sees an item of some interest, the invention could allow the user to quickly access further details, such as specifications, owner manuals, videos, comparison capabilities, etc., that would not be available in the catalog itself. Second, the user could order the item by selecting it in the manner consistent with selection as previously described. Third, the customer could quickly move back and forth through various possibilities. And of course, the invention allows a further significant advantage—all of these possibilities offered through the digital medium do not require any catalog at all. A simple advertisement or newspaper article or any other physical medium, such as a previously purchased item from the retailer, could contain the same machine-readable code with the same capabilities. The previously described techniques for visualizing the inside of physical items could likewise be incorporated into the catalog. Thus, for example, if a catalog includes a refrigerator, by selecting that refrigerator for further information, the customer could “look” inside the refrigerator—i.e., the invention would display to the customer the view as would exist inside the refrigerator, including, for example, the inside of the motor, or the inside of the freezer compartment.

The techniques described above by reference to a catalog could also be applied to flyers, books, owner manuals and any other print medium.

What we claim is:

1. A method of visualization comprising:
imaging a machine-recognizable graphic,
recognizing the machine-recognizable graphic,
associating that graphic with a location, and
displaying graphic information associated with that location.

2. The method of visualization of claim 1 where the machine-recognizable graphic is a two-dimensional machine-readable code.

3. The method of visualization of claim 2 where the two-dimensional machine-readable contains data used for associating the graphic with a location.

4. The method of visualization of claim 1 where the machine-recognizable graphic is a mark.
